(19) United States
(12) Patent Application Publication
(10) Pub. No.: US 2012/0061026 A1
(43) Pub. Date: Mar. 15, 2012

(54) Tacky Tape Device for Removing Dirty Objects

(76) Inventor: Ching-Chen Lu, Dounan Township (TW)

(21) Appl. No.: 12/879,078

(22) Filed: Sep. 10, 2010

(51) Int. Cl. B32B 38/04

(52) U.S. Cl. 156/510

(57) ABSTRACT

A tacky tape device includes a body defining a compartment for receiving a roll of tacky tape. The body further includes a tape exit in communication with the compartment. Two grooves are located on opposite sides of the tape exit. The tape exit allows an outer end of a tape section of the roll of tacky tape to extend out of the compartment of the body and engage with the tape section of the tacky tape to form a loop covering the tap exit and the grooves. A handle is mounted to a side of the body. The body is rotatably mounted around a shaft portion of the handle. The handle includes a sliding groove in which a cutter frame is slideably received. The cutter frame includes two cutters movable into the grooves to cut the loop while the cutter frame moves towards the body.

### BACKGROUND OF THE INVENTION

The present invention relates to a tacky tape device for removing dirty objects from a solid surface and, more particularly, to a rolling-type tacky tape device for removing dirty objects.

China Patent No. CN2160475 discloses a rolling-type tacky tape device for removing dirty objects. The tacky tape device includes a roll of tacky tape, a front support, a rear support, and a shaft/handle. The front and rear supports are mounted on opposite sides of the roll of tacky tape, and the shaft/handle is extended through the rear support, the roll of tacky tape, and the front support. When the tacky tape device is held by a user and rolled through a surface of an object, the fuzz, dust, and dirt can be adhered to the tacky tape and, thus, removed from the surface. Although the tacky tape device can avoid the dust from flowing into the air and has a simple structure and low costs and is easy to carry, there are no cutters to cut the used tape section from the roll of tacky tape, leading to inconvenience to the user.

Thus, a need exists for an improved tacky tape device having cutters to remove the used tape section.

### BRIEF SUMMARY OF THE INVENTION

The present invention solves this need and other problems in the field of convenient use of tacky tape devices by providing, in a preferred form, a tacky tape device including a body having a peripheral wall defining a compartment. The compartment is adapted to receive a roll of tacky tape having a tacky side and a non-tacky side. The peripheral wall includes an outer periphery and an inner periphery. A tape exit extends from the outer periphery through the inner periphery and is in communication with the compartment. First and second grooves are formed in the outer periphery and located on opposite sides of the tape exit. The tape exit is adapted to allow an outer end of a tape section of the roll of tacky tape to extend out of the compartment of the body and engage with the tape section of the tacky tape to form a loop surrounding the peripheral wall with the tacky side facing outward. The loop covers the tap exit and the first and second grooves. A roller is rotatably received in the tape exit. The roller is adapted to guide pulling of the tape section out of the compartment. A handle is mounted to a side of the body. The handle includes a grip portion and a shaft portion. The body is rotatably mounted around the shaft portion of the handle about an axis. The grip portion includes a sliding groove. A cutter frame is slideably received in the sliding groove. The cutter frame includes first and second cutters movable into the first and second grooves to cut the loop while the cutter frame moves towards the body. A trigger frame is fixed to the handle. A first trigger is rotatably mounted to the trigger frame. The first trigger is pivotable between an engagement position engaged with the body and a disengagement position disengaged from the body. The body is rotatable relative to the handle when the first trigger is in the disengagement position. The body is not rotatable relative to the handle when the first rigger is in the engagement position.

In the most preferred form, the cutter frame is slideable in the sliding groove in a direction parallel to the axis. The first trigger includes an upper portion that is engaged with an engaging groove of the cutter frame when the first trigger is in the disengagement position, preventing the cutter frame from sliding towards the body. The body includes a tube rotatably receiving the shaft portion of the handle. The tube has a positioning notch in an end thereof. A lower portion of the first trigger is engaged with the positioning notch when the first trigger is in the engagement position. The lower portion of the first trigger is disengaged from the positioning notch when the first trigger is in the disengagement position. A second trigger is pivotably mounted to the first trigger and releasably engaged with a locking block on the trigger frame. The first trigger is retained in the disengagement position when the second trigger is engaged with the locking block. The first trigger is movable between the engagement position and the disengagement position when the second trigger is disengaged from the locking block. A spring is provided to bias the second trigger to engage with the locking block. Another spring is provided to bias the first trigger to the engagement position.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a tacky tape device according to the preferred teachings of the present invention.

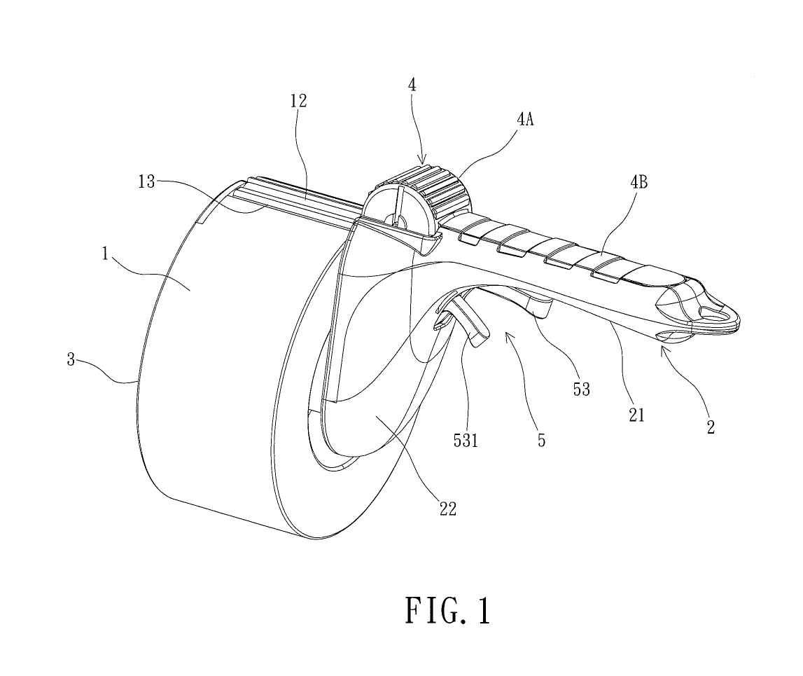

FIG. 2 shows another perspective view of the tacky tape device of FIG. 1 with a cutter frame moved.

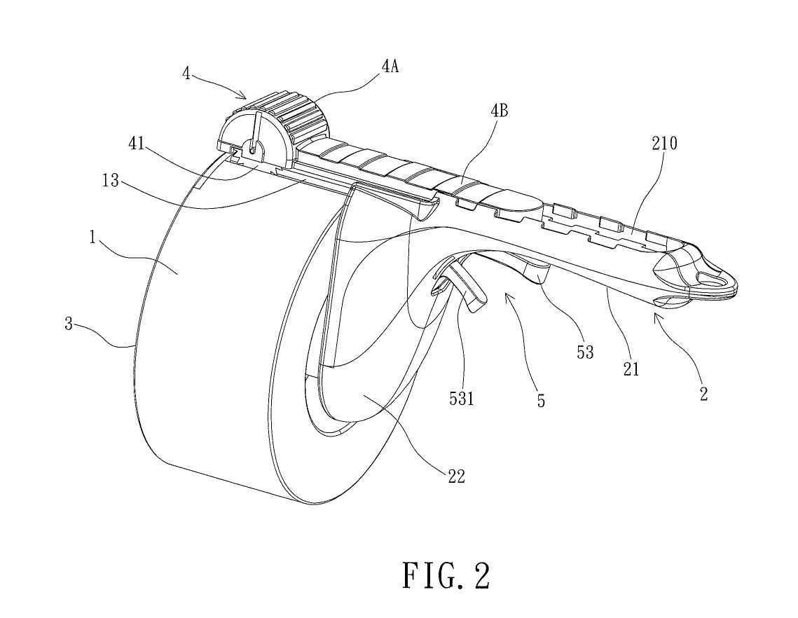

FIG. 3 shows an exploded, perspective view of the tacky tape device of FIG. 1.

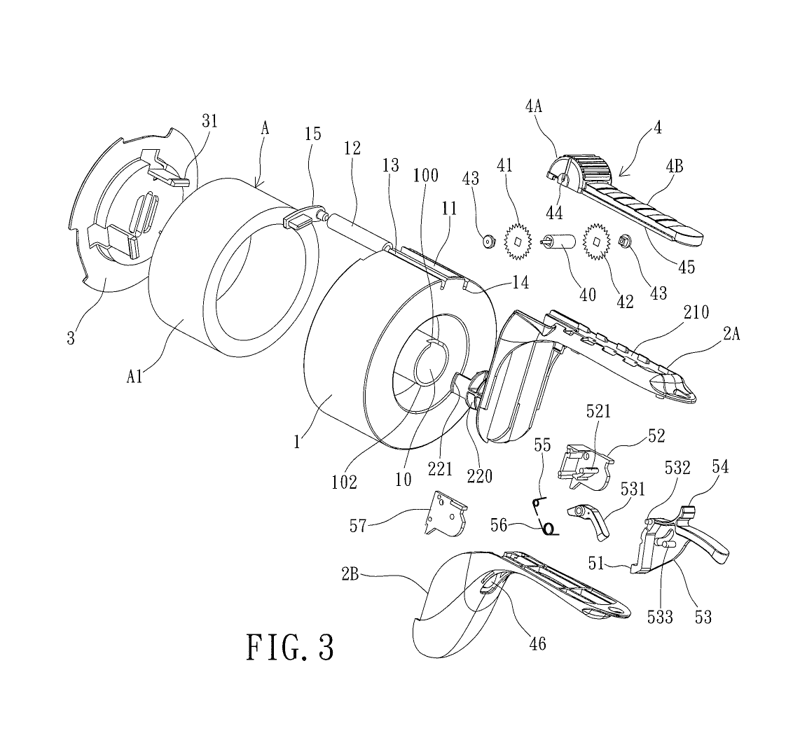

FIG. 4 shows an exploded, perspective view of the tacky tape device of FIG. 1.

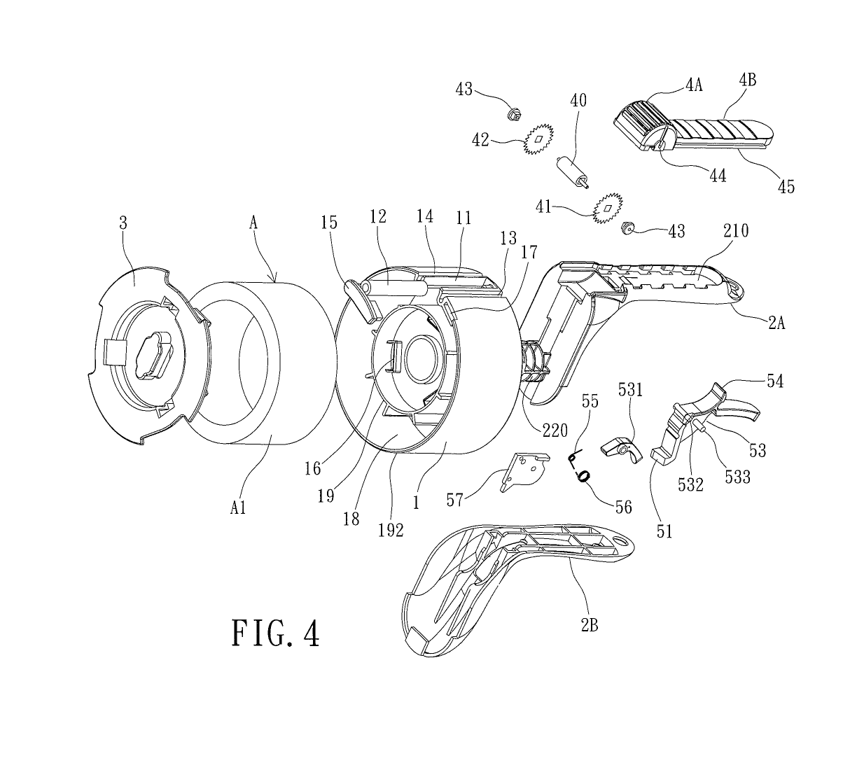

FIG. 5 shows a perspective view of a trigger device of the tacky tape device of FIG. 1.

FIG. 6 shows a perspective view of a trigger frame of the trigger device of FIG. 5.

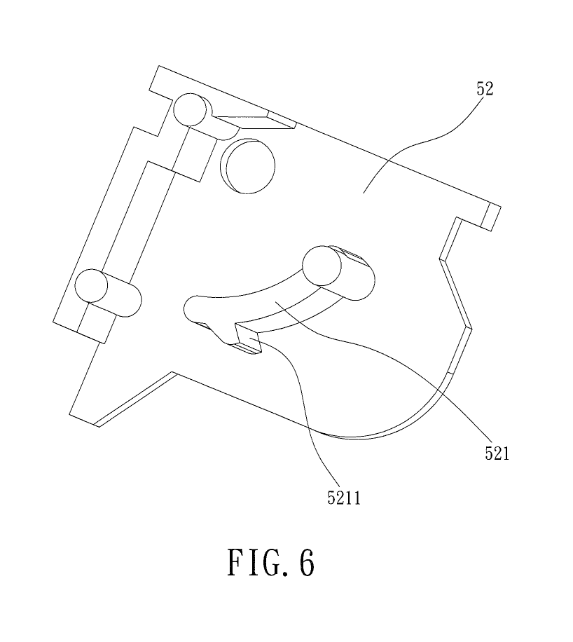

FIG. 7 shows a perspective view of the tacky tape device of FIG. 1 with a tape section of a roll of tacky tape pulled outward.

FIG. 8 shows a perspective view of the tacky tape device of FIG. 7 with a loop formed by the tape section after bonding an outer end of the tape section to the tape section.

FIG. 9 shows a perspective view of the tacky tape device of FIG. 8 with the cutter frame moved to cut the tape section.

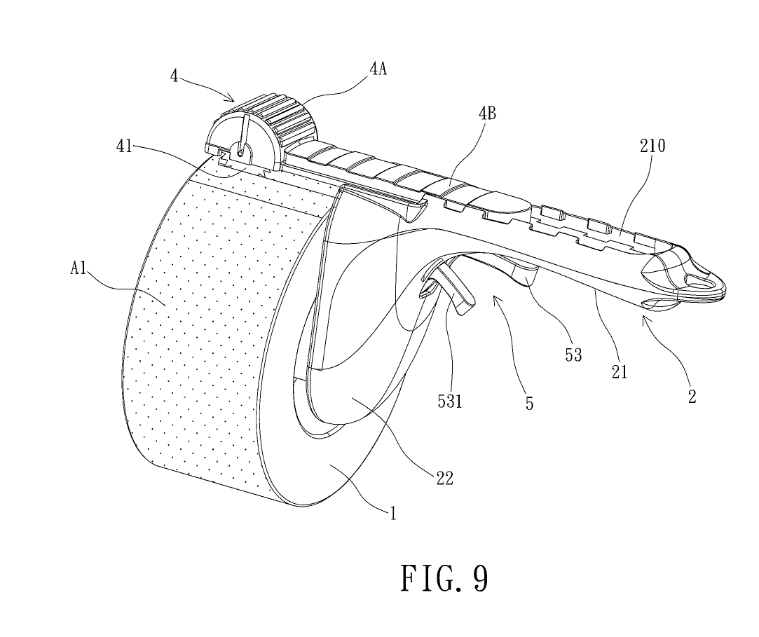

### DETAILED DESCRIPTION OF THE INVENTION

A tacky tape device for removing dirty objects according to the preferred teachings of the present invention is shown in the drawings and generally includes a body 1 for receiving a roll of adhesive tape or tacky tape A having a tacky side and a non-tacky side. The body 1 is substantially cylindrical and defines a compartment 18 rotatably receiving the roll of tacky tape A. The body 1 further includes a tape exit 11 in an outer periphery thereof and in communication with the compartment 18. In the most preferred form shown, the body 1 includes a hub 19 and a peripheral wall 192 surrounding the hub 19. The compartment 18 is defined between the hub 19 and the peripheral wall 192. The tape exit 11 extends from an outer periphery through an inner periphery of the peripheral wall 192 and is in communication with the compartment 18. A roller 12 is rotatably mounted in the tape exit 11 and retained in the tape exit 11 by a first end of roller retainer 15. The roller retainer 15 has a second end engaged with a fixing groove 17 in the peripheral wall 192 of the body 1. First and second grooves 13 and 14 are formed in the outer periphery of the peripheral wall of the body 10 and extend from a side through the other side of the body 10. First and second grooves 13 and 14 are on opposite sides of the tape exit 11. A plurality of engaging holes 16 is formed in the hub 19. A cover 3 is attached to a side of the body 1 and covers the compartment 18. The cover 3 includes a plurality of engaging members 31 engaged with the engaging holes 16. Furthermore, the body 1 includes a mounting hole 10 in a center thereof In the most preferred form shown, the mounting hole 10 is defined by a tube 102 having a positioning notch 100 in an end thereof.

According to the preferred form shown, a handle 2 is mounted to the other side of the body 1 and includes a grip portion 21 and a connecting portion 22. The grip portion 21 includes a sliding groove 210. The connecting portion 22 includes a shaft portion 220 rotatably received in the mounting hole 10. The handle 2 further includes an opening 46. In the most preferred form shown, the shaft portion 220 includes a snapping fastener 221 for engaging with the tube 102. Furthermore, the handle 2 is comprised of an upper handle part 2A and a lower handle part 2B. Further, the handle 2 is substantially L-shaped in cross section.

According to the preferred form shown, a cutter frame 4 is slideably mounted in the sliding groove 210 of the handle 2. The cutter frame 4 includes a shaft hole 44 and a cutter shaft 40 rotatably received in the shaft hole 44. First and second cutters 41 and 42 are mounted on two ends of the cutter shaft 40. In the most preferred form shown, each of the first and second cutters 41 and 42 is in the form of a wheel-shaped cutter. A cutter retainer 43 is mounted to each end of the cutter shaft 40 to prevent the first and second cutters 41 and 42 from disengaging from the cutter shaft 40. Furthermore, the cutter frame 4 includes an engaging groove 45. In the most preferred form shown, the cutter frame 4 includes a cutter holding section 4A and a manual portion 4B. The cutter holding portion 4A holds the first and second cutters 41 and 42 and the cutter shaft 40. The manual portion 4B includes the engaging groove 45. The cutter frame 4 can slide in the sliding groove 210 in a direction parallel to an axis defined by the shaft portion 220 such that the first and second cutters 41 and 42 can slide into the first and second grooves 13 and 14 to cut a tape section A1 of the roll of tacky tape A after the tape section A1 loses its tackiness.

According to the preferred form shown, a trigger device 5 is mounted to a bend in an adjoining area between the grip portion 21 and the connecting portion 22. The trigger device 5 includes a trigger frame 52 fixed to the handle 2. A locking block 521 is formed on the trigger frame 52 and has a catch 5211. The trigger device 5 further includes a first, larger trigger 53 having a pin 532 pivotably connected to the trigger frame 52, allowing pivotal movement of the first, larger trigger 53 between an engagement position and a disengagement position. In the most preferred form shown, the larger trigger 53 includes a lower portion 51 and an upper portion 54. The lower portion 51 extends through the opening 46 of the handle 2 into the body 1. When the larger trigger 53 is in the engagement position, the lower portion 51 is engaged with the positioning notch 100 of the tube 102, preventing relative rotation between the body 1 and the handle 2. When the larger trigger 53 is in the disengagement position, the lower portion 51 is disengaged from the positioning notch 100 of the tube 102, allowing the body 1 to rotate relative to the handle 2 about the axis. Furthermore, when the larger trigger 53 is in the disengagement position, the upper portion 54 extends into the engaging groove 45 of the cutter frame 4, preventing the cutter frame 4 from sliding towards the body 1. The trigger device 5 further includes a spring 55 for biasing the larger trigger 53 to the engagement position. A pin 533 is formed on the first, larger trigger 53. A second, smaller trigger 531 is pivotably mounted about the pin 533. The second, smaller trigger 531 has a stop 5311 releasably engaged with the catch 5211 of the locking block 521 on the trigger frame 52. A spring 56 is provided to bias the stop 5311 of the second, smaller trigger 531 to engage with the catch 5211. In the most preferred form shown, each of the springs 55 and 56 is in the form of a torsion spring. A trigger cover 57 is mounted to the trigger frame 52.

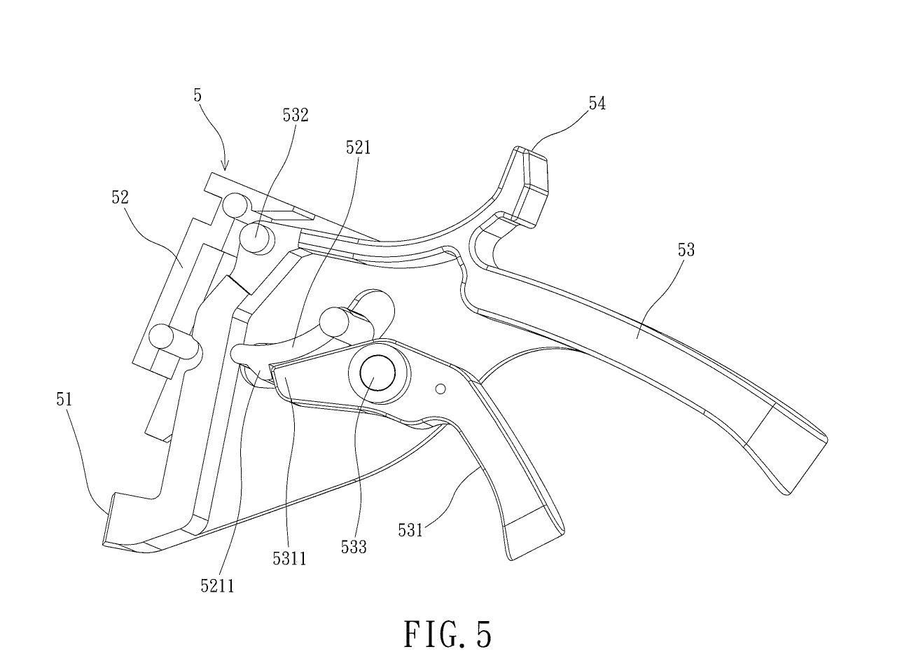

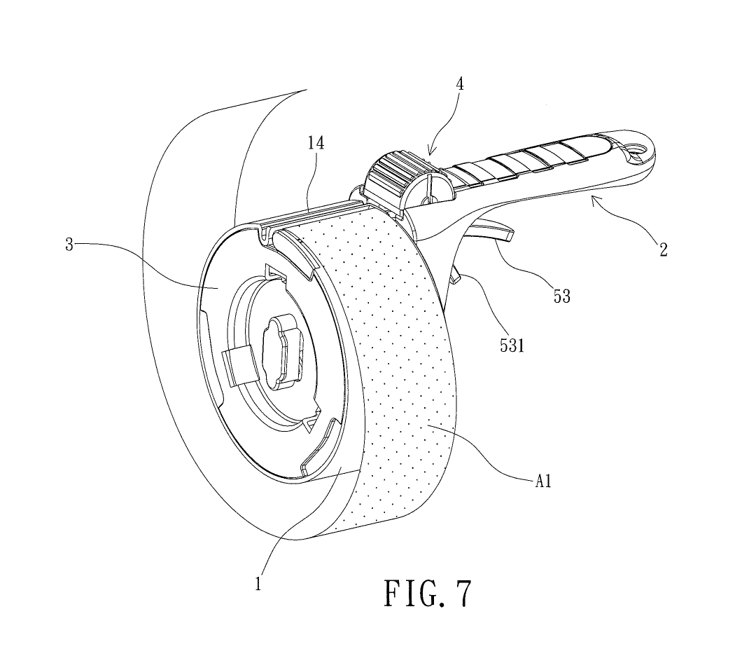

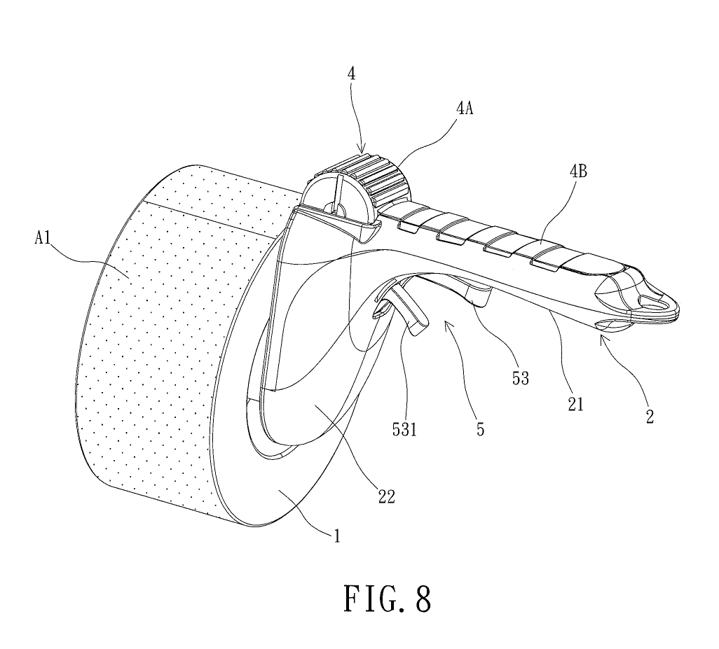

In use, the roll of tacky tape A is mounted in the body 1. An outer end of a tape section A1 is pulled out of the tape exit 11. The tape section A1 is wound around the body 1. The outer end of the tape section A1 is bonded to the tacky side of the tape section A1 to form a loop surrounding the peripheral wall 192 with the tacky side facing outward, as shown in FIGS. 7 and 8. The first, larger trigger 53 is moved to the disengagement position and retained in place by the locking block 521 that catches the second, smaller trigger 531 by the catch 5211, as shown in FIG. 5. The body 1 can rotate freely relative to the handle 2. Thus, the tacky tape device according to the preferred teachings of the present invention can now be used to remove dirty objects from a surface by the tacky side of the loop of the tape section A1. The first and second cutters 41 and 42 are outside of the first and second grooves 13 and 14. The upper portion 54 of the first, larger trigger 53 extends into the engaging groove 45 of the cutter frame 4 to prevent the cutter frame 4 from moving towards the body 1.

When the tacky side of the tape section A1 loses its tackiness and, thus, should be removed, the second, smaller trigger 531 is moved so that the stop 5311 disengages from the catch 5211 of the locking block 521. The first, larger trigger 53 is moved to the engagement position under the action of the spring 55. Thus, the lower portion 51 of the first, larger trigger 53 is engaged with the positioning notch 100 of the tube 102, preventing the body 1 from rotating relative to the handle 2. In a case that the positioning notch 100 is not aligned with the lower end 51 of the first, larger trigger 53, the body 1 can be rotated until the positioning notch 100 is aligned and engaged with the lower end 51 of the first, larger trigger 53. Thus, the body 1 is positioned relative to the handle 2. The upper portion 54 of the first, larger trigger 53 is disengaged from the engaging groove 45 of the cutter frame 4. Thus, the cutter frame 4 can be pushed by the finger of the user towards the body 1. As a result, the first and second cutters 41 and 42 can move into the first and second grooves 13 and 14 to cut the tape section A1.

Since the tape exit 11 is located between the first and second grooves 13 and 14 (namely, between the first and second cutters 41 and 42), the uncut section of the tape section A1 can be used as a new outer end for pulling a new, unused tape section A1 outward. The new, unused tape section A1 is moved across the roller 12 that assists in outward pulling of the new, unused tape section A1 and that prevents the new, unused tape section A1 from being cut by the first and second cutters 41 and 42. After cutting, the cutter frame 4 is moved back to its original position outside of the first and second grooves 13 and 14. The new, unused tape section A1 is wound around the body 1. The outer end of the new, unused tape section A1 is bonded to the tacky side of the new, unused tape section A1 to form a loop surrounding the peripheral wall 192 with the tacky side facing outward. The first, larger trigger 53 is moved to the disengagement position and retained in place by the locking block 521 that catches the second, smaller trigger 531. The body 1 can rotate freely relative to the handle 2. Again, the tacky tape device according to the preferred teachings of the present invention can be used to remove dirty objects from a surface by the tacky side of the loop of the new, unused tape section A1.

The tacky tape device according to the preferred teachings of the present invention can be used to remove dirty objects while the body 1 rotates relative to the handle 2. The first and second cutters 41 and 42 can cut the used tape section A1 with a small section between the first and second grooves 13 and 14 left for pulling a new, unused tape section A1 outward. Furthermore, the trigger device 5 allows the user to conveniently proceed with cutting operation. Further, most components of the tacky tape device according to the preferred teachings of the present invention can be made of plastic material to reduce the costs. Compared to conventional tacky tape devices, the tacky tape device according to the preferred teachings of the present invention provides convenient use and has a high efficiency in removing dirty objects while allowing easy removal of the used tape section A1. The costs are, thus, reduced.

Although specific embodiments have been illustrated and described, numerous modifications and variations are still possible without departing from the essence of the invention. The scope of the invention is limited by the accompanying claims.

1. A tacky tape device comprising, in combination:
a body including a peripheral wall defining a compartment, with the compartment adapted to receive a roll of tacky tape having a tacky side and a non-tacky side, with the peripheral wall including an outer periphery and an inner periphery, with a tape exit extending from the outer periphery through the inner periphery and in communication with the compartment, with first and second grooves formed in the outer periphery and located on opposite sides of the tape exit, with the tape exit adapted to allow an outer end of a tape section of the roll of tacky tape to extend out of the compartment of the body and engage with the tape section of the tacky tape to form a loop surrounding the peripheral wall with the tacky side facing outward, with the loop covering the tap exit and the first and second grooves, with a roller rotatably received in the tape exit, with the roller adapted to guide pulling of the tape section out of the compartment;
a handle mounted to a side of the body, with the handle including a grip portion and a shaft portion, with the body rotatably mounted around the shaft portion of the handle about an axis, with the grip portion including a sliding groove;
a cutter frame slideably received in the sliding groove, with the cutter frame including first and second cutters movable into the first and second grooves to cut the loop while the cutter frame moves towards the body;
a trigger frame fixed to the handle; and
a first trigger rotatably mounted to the trigger frame, with the first trigger pivotable between an engagement position engaged with the body and a disengagement position disengaged from the body,
with the body rotatable relative to the handle when the first trigger is in the disengagement position,
with the body not rotatable relative to the handle when the first rigger is in the engagement position.

2. The tacky tape device as claimed in claim 1, with the cutter frame slideable in the sliding groove in a direction parallel to the axis, with the cutter frame including an engaging groove, with the first trigger including an upper portion, with the upper portion of the first trigger engaged with the engaging groove of the cutter frame when the first trigger is in the disengagement position, preventing the cutter frame from sliding towards the body.

3. The tacky tape device as claimed in claim 2, with the first trigger further including a lower portion, with the body including a tube rotatably receiving the shaft portion of the handle, with the tube having a positioning notch in an end thereof, with the lower portion of the first trigger engaged with the positioning notch when the first trigger is in the engagement position, with the lower portion of the first trigger disengaged from the positioning notch when the first trigger is in the disengagement position.

4. The tacky tape device as claimed in claim 3, further comprising, in combination: a second trigger pivotably mounted to the first trigger, with the trigger frame including a locking block, with the second trigger releasably engaged with the locking block, with the second trigger pivotable between a first position engaged with the locking block and a second position disengaged from the locking block, with the first trigger retained in the disengagement position when the second trigger is engaged with the locking block, with the first trigger is movable between the engagement position and the disengagement position when the second trigger is disengaged from the locking block.

5. The tacky tape device as claimed in claim 4, further comprising, in combination: a spring for basing the second trigger to the first position.

6. The tacky tape device as claimed in claim 4, further comprising, in combination: a spring for biasing the first trigger to the engagement position.

7. The tacky tape device as claimed in claim 4, with the first and second cutters being wheel-shaped cutters.

8. The tacky tape device as claimed in claim 4, further comprising, in combination: a cover mounted to another side of the body and covering the compartment; and a roller retainer having a first end rotatably retaining the roller in the tape exit and a second end, with the peripheral wall of the body including a fixing groove, with the second end of the roller retainer engaged in the fixing groove.

9. The tacky tape device as claimed in claim 8, with the body including a hub surrounded by the peripheral wall, with the compartment defined between the hub and the peripheral wall, with the cover including a plurality of engaging members, with the body including a plurality of engaging holes in the hub, with the plurality of engaging members engaged with the plurality of engaging holes.

10. The tacky tape device as claimed in claim 4, with the cutter frame including a shaft hole and a cutter shaft rotatably received in the shaft hole, with the first and second cutters mounted on the cutter shaft.

11. The tacky tape device as claimed in claim 10, with the cutter frame including a cutter holding portion and a manual portion, with the cutter holding portion holding the first and second cutters and the cutter shaft, with the manual portion adapted to be operated by a user to slide the cutter frame in the sliding groove of the handle.
